(19) United States
(12) Patent Application Publication
(10) Pub. No.: US 2006/0102019 A1
(43) Pub. Date: May 18, 2006

(54) Method and arrangement for calendering a web

(76) Inventor: Pasi Kakkonen, Mantsala (FI)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/533,000

(22) PCT Filed: Oct. 30, 2002
(86) PCT No.: PCT/EP02/12227

§ 371 Date: Sep. 23, 2005

(51) Int. Cl. B30B 3/04

(52) U.S. Cl. 100/41; 100/161

(57) ABSTRACT

Method for treating a web (W) with heat and compression in a cal ender arrangement (13), which in addition to a first stack (15) is provided with a second stack (33) each of which including one or more calendering nips (0), wherein the calendering treatment is selected to be performed in calendering nips (0) which can be of the first stack (15) and/or of the second stack (33) both of the stacks (15, 33) or part of the stacks (15, 33) being usable independently or as a combination together with the other stack (15, 33) or part of the other stack (15, 33).

The invention relates to a method for treating a web with heat and compression in a calender arrangement and a calender arrangement having a supporting frame and a stack of calender rolls for calendering a web, such as paper or board. The invention relates also to a method for improving the performance of an existing calender arrangement.

A calender arrangement means here the whole calender arrangement containing all parts related to the machine including for example frames, rolls, control system, web handling equipment and auxiliary equipment related to the process of glazing the web. A calender roll means here a revolving roll which has plain metal surface or surface covering made of polymers or other flexible, elastic or resilient material and the calender roll is used for treating the web in a nip formed between two calender rolls. A stack means here a stack of at least two calender rolls arranged next to each others forming nips between the calender rolls. The stack can be opened so that in the nip the distance between the surfaces of the calender rolls is greater than the thickness of the web. A treating mode means here a way to feed the web through the calender arrangement from unwind to the reel-up. To select or selectable means here a possibility to a user of the machine to take some or all features into the use without laborous machanical or automation changes, only with some changes in adjustments and changes concerning auxiliary equipment like guide rolls, moistening devices and similar.

It is known from document WO 02/06584 that it is possible to modify existing calender to a calender of modern type with calender roll relief devices by using auxiliary frame. The intermediate rolls are attached revolvingly to arms pivoted on auxiliary frames, which in turn are attached to vertical portions of the supporting frame of the old calender. With the help of auxiliary frames, all the necessary equipment for modernization can be incorporated in this frame, and the vertical portions of the old frame that existed prior to the rebuilds, that is, the vertical posts designed to carry the vertical spindles and shaped to act as guides for the bearing housings of the rolls need only be modified in view of mounting the auxiliary frames. The auxiliary frames can be designed as profiles, which in part damp around the old guides of the frame.

It is known from the document U.S. Pat. No. 440,377 to have two calender stacks in one calender arrangement and to have sheet feeding devices between these two stacks. The stacks are driven by one common bottom roll of the two stacks.

It is known from document U.S. Pat. No. 5,911,174 to provide a calender with two calender roll stacks which are positioned one atop of the other. Each roll stack may be separately operable. Both roll stacks may be arranged in a common machine frame to simplify the overall design of the calender. Further, the two roll stacks may be aligned with each other, so as to support more easily the upper roll stack. It is preferred, that each roll stack includes five rolls and that the machine frame or stanchion may correspond to that of known 12-roll calender. In many instances and applications of web processing, the calender arrangement of the publication is intended to replace the prior art 12-roll calender. The existing machine frame for the old calender may be retrofit and used to embody the calender of this publication.

It is known from document U.S. Pat. No. 4,375,188 a on-machine supercalender apparatus adapted to be located at the discharge end of a paper making machine of the type which includes hard and soft calender rolls forming soft calendering nips with each other. The calender rolls are arranged in at least three roll groups, each of the calender roll groups consisting of three calender rolls, namely a central hard calender roll and two outer soft calender rolls. The calender roll groups are separate from each other in that the calender rolls of one group are neither directly or indirectly in nip contact with the calender rolls of another group. At least a majority of the soft calender rolls are replaceable during operation of the apparatus without any significant interruption in operation.

It is known from the document U.S. Pat. No. 5,806,415 a method and system for controlling stack of calender rolls arranged one above another and adjacent rolls in the stack are in nip contact with one another. The document describes especially quick-opening arrangement and hydraulic circuit in a calender.

It is known from document DE 19940897 to have two calender stacks where hard and soft covered rolls are arranged so that in the first stack the top roll is hard roll and in the second stack the top roll is soft roll. The diameters of the calender rolls in one stack are all different in diameter. In the second stack rolls are like in first stack but the running direction is inverse.

It is known from the document EP 1092805 A2 to have two stacks of calender rolls arranged in a V form opening upwards or downwards and the web is guided from the stack to the other in place where the distance from the stack to the other is relatively short.

It is known from document U.S. Pat. No. 4,332,191 to have at least two stacks of calender rolls mounted on a unitary frame spaced from one another. Each calendering unit includes at least one intermediate roll and two hard end rolls defining a respective pair of nips with the intermediate roll on substantially diametrically opposed sides thereof. The intermediate roll of a calendering unit may comprise a soft roll so that the pair of nips of the calendering unit is soft nips so that the calender apparatus comprises a supercalender.

It is known from document U.S. Pat. No. 6,003,440 a method for calendering a web such as paper web in a multi-nip calender or supercalender, in which the web is passed through calendering nips formed by rolls placed in two or more stacks of rolls. The web is passed alternatingly from the corresponding calendering nip in each stack of rolls into the calendering nip in the following stack of rolls. In other words, the web is passed from a first calendering nip in a first stack of rolls to a first calendering nip of a second stack of rolls to a second calendering nip in the second stack of rolls, from the second calendering nip in the second stack of rolls to a second calendering nip in the first stack of rolls, and after the second calendering nip in the first stack of rolls to further processing.

It is known from document U.S. Pat. No. 5,651,863 to have two stacks of calender rolls inside a hood for keeping the calendering environment in desired temperature and humidity.

In general a calender is designed for a certain range of process parameters based on trial results. The starting point of designing the calender specification in most cases is the already produced base paper. The trials are run and according to the results of these trials the configuration of a calender arrangement is designed. This includes the number of nips; the calender roll diameters, the minimum and the maximum linear loads in the nip, the running speed, the temperature of heated rolls, moistening devices, etc. There is a drawback in present calender arrangements that it is difficult to modify when the base paper changes for some reason, for example due to increase of portion of recycled fiber in stock. It is the object of the invention to provide an improved method and arrangement for increasing the versatility of a calender arrangement.

This is for example solved in that in addition to a first stack the calender arrangement according to the invention is provided with a second stack each of which including one or more calendering nips, the calendering treatment is selected to be performed in calendering nips which can be of the first stack and/or of the second stack where both of the complete stacks or parts of the stacks can be used independently or as a combination together with the other complete stack or parts of the other stack. Normally, a calender is designed only for one treating mode so that there are only one way to feed the web through the machine from unwind to the stack or stacks and further to the reel-up. This is in most cases all what is needed, but when time goes and the calender becomes older it often happens that also the material to be treated changes and the existing configuration is not any longer the most suitable for that new task. The lifetime of a calender arrangement is easily more than 25 years and there are plenty of existing calenders designed for very narrow range on process parameters. The present invention enables a fast and easy way to modernize a calender to fulfill the requirements of modern time without removing the possibility to use the original calendering concept.

According to the invention, it is possible to create several different new treating modes as follows: the web is guided first through all the nips of the first stack and after that through all the nips of the second stack. Another alternative is that the web is guided first partially through the nips of the first stack and after that at least partially through nips of the second stack. Still another possibility is that the web is guided first partially through the nips of the first stack and after that at least partially through the nips of the second stack and after that partially through the remaining nips of the first stack. Further still another possibility is that the web is guided first partially through the nips of the second stack and after that at least partially through nips of the first stack. Still another possibility is that the web is guided first partially through the nips of the second stack and after that at least partially through the nips of the first stack and after that partially through the remaining nips of the second stack. All these different treating modes enables to perform the most suitable calendering process to the web and it enables that the properties of the web may vary significantly from those of the original web the calender arrangement is designed for. In other words, scale of possible process parameters is widened and it makes possible to produce new type of web grades with the calender arrangement.

It should be noted that at least one of the two stacks are designed such that they provide a complete web treatment arrangement fullfilling predetermined parameters, so that it is possible to exclusively use that stack without the necessity of incorporating the other stack or parts of it into the web treatment process.

The object of the invention is also solved in that in addition to a first stack the calender arrangement is provided with a second stack each of which including one or more calendering nips, the calendering nips to be used are selectable out of the first stack and/or of the second stack wherein both of the stacks or parts of the stacks are useable independently or as a combination together with the other stack or parts of the other stack. Also the calender arrangement comprises the first stack and the second stack and said second stack is arranged on a second frame and said second frame is removable connected to a first frame. This creates a possibility to minimize the preparation work of an existing calender arrangement to modify it according to the invention. In a calender stack the manufacturing requirements are very high, all parts must be precisely fitted and built in a such way that high loads of fast running machine does not cause too high stress level to the mechanical construction. As the lifetime requirement is very long, the allowed stress levels are rather low due to dynamic fatigue load.

In a calender arrangement according to the invention the second frame is adjustably interconnected to the first frame. A fast running web is very sensitive to all kind of misalignment errors of rolls contacting the running web. The runnability of the calender arrangement is dependent on these alignments and runnability is one key factor that determines how much production it is possible to do with the calender arrangement. In a modification from old one stack calender arrangement configuration to the calender arrangement according to the invention, said second frame is adjustable in position in relation to the first frame such that the adjustment is feasible in the directions X, Y or Z independently from each others.

The above-mentioned and further solutions of the problem according to the invention with their features and advantages result from the following description of embodiments.

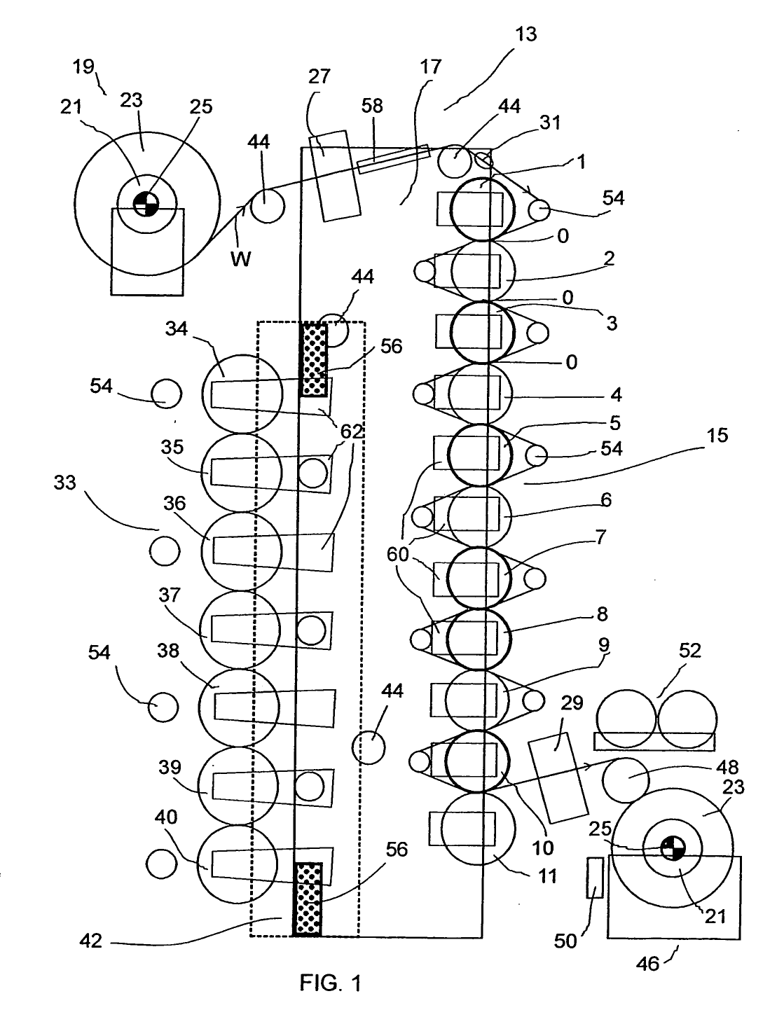

FIG. 1 shows schematically a calender arrangement according to one embodiment and the treating mode as it is in existing calender.

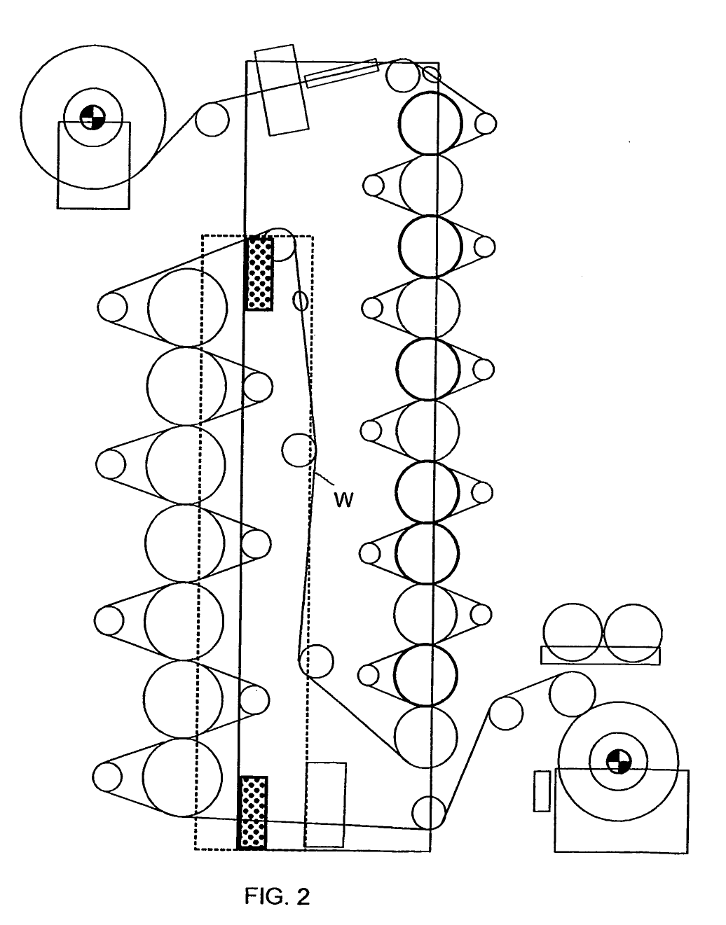

FIG. 2 shows schematically other option of treating mode according to one embodiment.

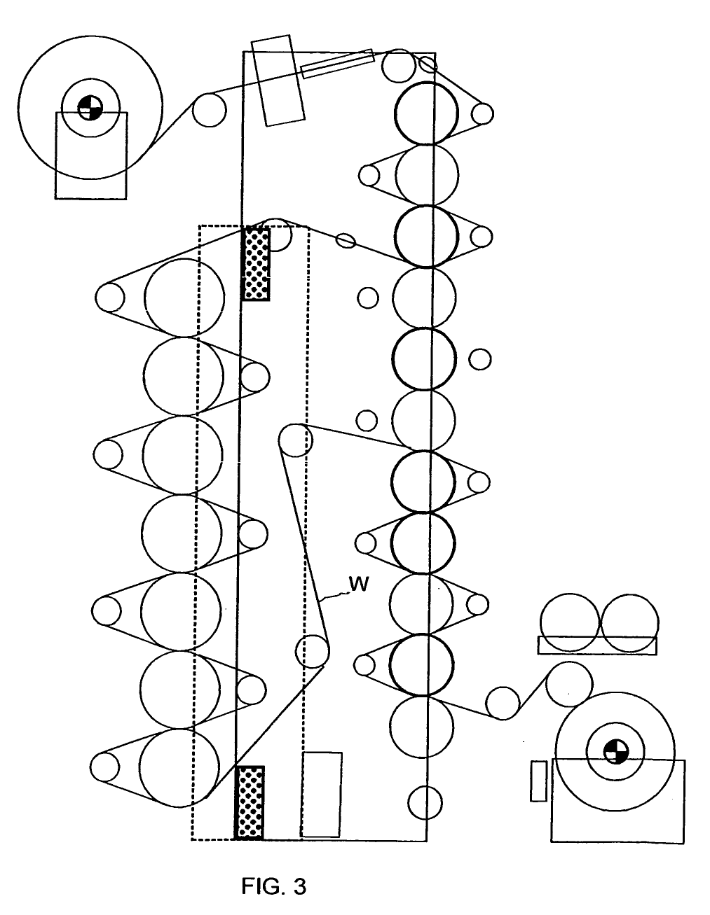

FIG. 3 shows schematically still another option of treating mode according to one embodiment.

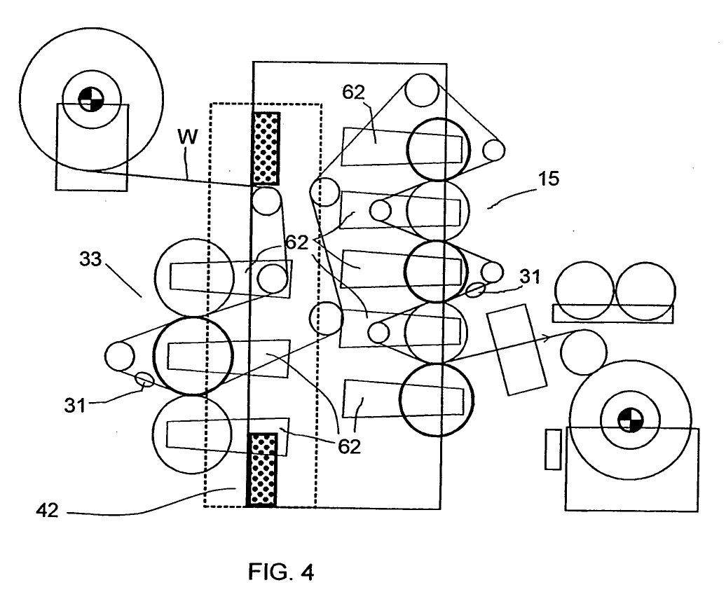

FIG. 4 shows schematically still another option of treating mode according to one embodiment.

FIG. 1 shows a calender arrangement according to one embodiment of the invention. The first calender rolls 1 to 11 are arranged revolvingly on the top of each other's so that they form a first stack 15. Also a second stack 33 of revolving calender rolls 34 to 40 is arranged. The calendering nips 0 to be used are selectable out of the first stack 15 and/or of the second stack 33 wherein both of the stacks 15 and 33 or parts of the stacks are useable independently or as a combination together with the other stack or parts of the other stack. The arragement enables a large variety of possibilities how the web can be guided through the whole calender arrangement 13. It can be guided through the first stack exclusively (as shown in FIG. 1), the complete first stack to the complete second stack (as shown in FIG. 2), first to the second stack and then to the first stack, partly through the first stack then to second stack and possible back to the remaining part of the first stack (FIG. 3) or viceversa of, through the complete second stack exclusively or partially through either of the stacks. Also it is possible to have a different number of calender rolls as shown in FIG. 4.

The second stack 33 is arranged through levers 62 to a separate second frame 42, which is removably attached to the first frame 17. The second frame comprises at least two parts of frames; one part in tending side and other part in drive side of the machine arrangement and appropriate number of cross-brackets. Interconnection sections 56 between the first and the second frame are designed so that it requires minimum amount of interconnection preparations to the first frame but the interconnection still creates fixed and sturdy mechanical connection between the first and second frame. The second frame has all the features of the first frame; sometimes it is useful to attach also a number of guiding rolls and tail threading equipment to the second frame. The interconnection section 56 between the first and the second frame is designed, so that it enables very accurate positioning of the second frame 42 compared to the first frame 17. The interconnection allows adjustments in X (horizontal, in direction of the length of the machine), Y (horizontal, in cross direction of the machine) and Z (vertical) directions and most preferably the adjustment of one direction does not change the position in one of the other coordinates. The positioning accuracy must be approximately 1/100 mm. For attaching the second frame 42 to the first frame 17 a bolted joint or similar arrangement is preferred.

The fixed first frame 17 is attached to foundations of building. The first frame is made of steel, cast iron or other suitable material, which forms solid basement for the calender arrangement. The first frame is also constructed, so that it is formed from at least two parts, the other part is located on the tending side of the paper or board making machine and the other part is located on the drive side of the machine. Between these two parts there are cross-brackets mechanically connecting these two parts of the first frame 17. The cross-brackets may contain electric cables and hydraulic pipelines going from side to side.

Calender rolls 1 to 11 are covered with soft coverings (conventional cotton or polymer covering) or they have plain hard metal outer surface. The diameter of a calender roll is selected according to the wanted process conditions, typically it is from 300 mm up to 1200 mm and more. Calender rolls in different positions might have different inner structure; they might comprise heating equipment or deflection compensating arrangement. In the first stack 15 the calender rolls 1,3,5,7,8 and 10 are soft covered and the rolls 2, 4, 6, 9 and 11 are hard covered. Also other arrangements of different type of rolls are possible.

The calender rolls in the second stack are similar or different type of calender rolls than in the first stack 15. The second stack 33 includes two or more calender rolls, the number of calender rolls in the second stack depends on frame construction and properties of the web which is intended to treat with the second stack. Also the diameter of the calender rolls in the second stack is the same or different to the calender rolls in the first stack.

The calender rolls 1 to 11 of the first stack are movably attached to a first frame 17 through levers 60. The calender rolls are pressed against each other's by means of force elements such as hydraulic cylinders. A contact point or line between two calender rolls where the treating of a web W happens is the nip 0. The levers have a stand for a calender roll bearing housings and the levers are attached to the first frame by means of a bearing arrangement. The first frame includes a number of pivot joints or a sliding bearing arrangement where the levers 60 are attached. Distance between the pivot joints is approximately the diameter of a calender roll. A lubricated bronze bearing is commonly used bearing type here. In the linear sliding bearing type a spindle nut or other similar arrangement is used for moving vertically the calender rolls 1 to 11. In the embodiment of FIG. 4 the first stack 15 is also of modern type with similar levers 62 as in the second stack 33.

A unwinding section 19 is located in the upper portion of the calender arrangement. It is the first element in process direction of a calender arrangement 13. A paper or board web W to be processed is stored on a web roll 23. The web roll is wounded on reel spool or winding core 21 depending on the machine arrangement. The reel spool or winding core comprises a shaft and a bearing housings separated from the shaft. The reel spool together with the web roll is attached through a coupling device to a drive 25. The drive is connected to a control system. The reel spool together with the web roll is supported by a reeling frame, which carries the whole weight of web roll and reel spool. The unwinding section is equipped with a splicing device. The splicing device includes a lifting device and a transport device, a joining device with a tape arrangement and a full width cutting device.

A first measuring device 27 has a measuring head and a cross directional guiding arrangement for the measuring head. The device measures different properties of the web for example moisture, ash content, thickness, gloss etc. before the web is processed. A web tension-measuring device is also included in this section. Tension measuring can be based on guiding roll weight measurement or on an air pressure caused by the travelling web. A second measuring device 29 is similar to the first measuring device 27 but it measures properties of the web W after the calendering process.

A tail threading device 58 is arranged to every free draw of the web. The tail threading device is a rope arrangement, a belt arrangement, an underpressure or overpressure arrangement or a combination of these. It has a number of guiding devices which guides the web through the calender from the unwinding position to a reel-up position.

Guiding rolls 44 are mounted to the calender frames to such locations that the free draws between guiding rolls stay relatively short, for example half the width of the web if the web is 10 meters wide. Special type of guiding roll called spreading roll is arranged in appropriate positions for example before the first nip 0 of the first stack 15. Flyer rolls 54 are used between two nips 0 to turn the web coming from the one nip to the following nip 0.

A moistening device 31 moistens either of the sides of the web and it can be controlled in cross direction of the web so that it can create different moisture profiles to the web. The moistening device 31 is attached either to the first frame 17 or to the second frame 42 or it has a frame of it's own. The moistening devices 31 can be located between one nip 0 and the following nip 0 in either of the stacks (as shown in FIG. 4) or between stacks 15 and 33.

Between the first stack 15 and the second stack 33 a number of guiding rolls 44, tail threading devices 58 and moistening devices 31 are arranged.

A reel-up 46 rolls the calendered web back to a roll 23. The roll is wound on similar reel spool 21 or winding core, as it is unwound at the unwinding section 19. The main parts of the reel-up are frame, pressure roll 48, drives 25, reel change device 50 and reel spool storage 52 for empty reel spools. The reel-up is equipped with oscillating device.

The following describes function of above mentioned arrangement and some benefits achieved with the method.

Calendering arrangement is normally designed for certain range of process parameters and ways to operate it. In the calender stack the web is treated by the effect of heat and compression. There are several elements which affects the compression: diameter of the calender rolls, module of elasticity in the nip, compressibility and what kind of shear force is created, surface smoothness, etc. The properties of the web itself: moisture, pulp and fibers, binding agent, ingredients, etc. together with the elements of compression determines the final result of the calendering process.

By selectively using the second stack or parts of it, it is possible to use several different treating modes of the web in the calender arrangement. These increased possibilities enhances the grade variation significantly, it is not only possible to produce old grade it used to produce, but also several new grades. The treating modes can be created, so that the web runs between the first and the second stack. For example, the following treating modes are possible:

Unwind->complete first stack->reel-up, this is the original SC-mode (FIG. 1)

Unwind->complete second stack->reel-up, this is so called OptiLoad-mode

Unwind->complete first stack->complete second stack->reel-up (FIG. 2)

Unwind->part of first stack (2 nips)->complete second stack->part of first stack (5 nips)->reel-up (FIG. 3)

Unwind->second stack->first stack->reel-up

Unwind->part of second stack (1 nip)->complete first stack->reel-up

Unwind->5 nips one stack->5 nips other stack->reel-up

Unwind->3 nips one stack->5 nips other stack->reel-up

Unwind->5 nips one stack->3 nips other stack->reel-up

Unwind->2 nips one stack->1 nips other stack->reel-up

Unwind->2 nips one stack->4 nips other stack->reel-up (FIG. 4)

At least the second stack 33 is of modern calender type with multiple nips. One preferred embodiment is described in fore mentioned U.S. Pat. No. 5,806,415. It has preferably more than one nip, for example 6 nips (7 calender rolls). It has a calender roll weight relief system and possibility to control independently each nip of the second stack. The linear load is adjustable so that the load in each nip can be the same, for example 100 kN/m to 425 kN/m. The calender rolls in the second stack have drives, all the calender rolls may have an own drive. The modern type of calender rolls used in this second stack enables longer running times and faster process speed with less maintenance required. Mainly this is due to improved characteristics of the modern polymer coverings, which can offer several advantages over the traditional ones.

The first stack 15 is of conventional type of supercalender. Naturally it can be also of the modern type with multiple nips. The calender rolls 1,3,5,7, 8,10 are cotton filled rolls and the calender rolls 2, 4, 6, 9 and 11 are so called chilled cast iron rolls. The diameters of the rolls are approximately 560 to 1000 mm and the compression or linear load varies from the first nips 120 kN/m to the bottom nips 325 kN/m. This means that the nip load between the calender rolls 1 and 2 is 120 kN/M and between the calender rolls 10 and 11 it is 325 kN/m. With this type of arrangement it is possible to create certain grade of supercalendered paper (SC-paper). The possibilities of controlling the first calender stack are quite limited, it is possible to alter the process parameters only inside the originally designed values. Some of the rolls are driven not necessary all. Typically the bottom roll 11 is driven and it is also equipped with deflection compensating elements.

The second stack 33 allows also the decrease of linear loads in the first stack 15, because the number of nips 0 can be selectively increased. This enables faster running speeds because the load of the calender roll is reduced and the heating effect of the nips under deformation is reduced. Also the tendency of stack vibration or barring is reduced due to reduced linear load. It is also possible to increase linear load in the beginning of the calendering process and reduce the linear load in last portion of the calendering process to reduce the lost of bulk during the process.

The installation of the second frame enables the attachment of all auxiliary equipment in an efficient way. It is not necessary to modify the first frame 17 in a large extent but just so that the optional installation of the second frame 42 is possible. An important detail in the attachment is to create sturdy connection that can be adjusted accurately. The web must run in the calender arrangement smoothly and the alignment of the stacks and the calender rolls as all the guide rolls too is one main element here.

Between these stack changes it is possible to insert moistening devices 31 to further affect the calendering result and avoid the unnecessary drying of the web. With these alternating treating modes it can be created a whole sortiment of new web grades instead of the old limited configuration.

In the unwinding section 19 the function is to unwind the web roll and maintain proper tension in the web. The drive brakes the unwound roll according to the tension measurement. Proper tension is such that the web does not flap and it runs smoothly to the process. The splicing device joins the web from nearly completely unwound roll to a new web coming from a new web roll. This enables continuous operation of the calender and reduces the laborious tasks of the operating crew.

In calendering process the aim is to affect on physical properties of the processed web, for example gloss, thickness, surface smoothness, etc. By using measuring devices before and after the calender stack or stacks, it is possibly to monitor these properties on-line during the process.

The function of the guiding rolls 44 is to guide the web into the calender stack so that runnability of the whole calender arrangement is as good as possible. The runnability means that the web runs smoothly without disturbance to the process. The spreading roll spreads the web so, that it won't overlap just before going in the calender stack.

Theoretically it is also possible to run the calender arrangement 13 at the same time as the other stack is under maintenance, but due to safety reasons this is not recommended. If a tool goes through a calender nip, the calender roll coverings may be seriously damaged and pieces of roll covering may hit the maintenance crew causing severe injuries.

The following example explains some benefits accieved with the invention. The calender arrangement has produced SC-grade paper for ten years. The base paper used to contain about 10% of recycled fiber and due to availability reasons of different stock materials, the portion of the recycled paper in the stock is increased to the 35%. The calendering arrangement comprising only the first stack does not produce any longer adequate calendering result for the new type of web. The measured web properties; gloss, smoothness, bulk, etc are deteriorated. It is possible to select the optimal treating mode for the new base paper, by introducing the optional second stock of modern calender type. This new selection can be for example three nips of the second stack run with a load of 250 kN/m at each nip and having hard rolls at the top side of the web and then further processing the web in the three nips between the calender rolls 8,9,10 and 11, having load of 250 kN/m to 300 kN/m and having the hard rolls at the wire side of the web. As a result of the selection according to the invention, the gloss of the web remains the same as it was prior to the raw material change, but the bulk is better than used to be.

The following numbers are used in figures:

W web (paper or board)

0 nip

1 calender roll (top roll of the first stack)

2 calender roll

3 calender roll

4 calender roll

5 calender roll

6 calender roll

7 calender roll

8 calender roll

9 calender roll

10 calender roll

11 calender roll (bottom roll of the first stack)

13 calender arrangement

15 first stack

17 first frame

19 unwinding section

21 reel spool

23 web roll

25 drive

27 first measuring device

29 second measuring device

31 moistening device

33 second stack

34 calender roll (top roll of the second stack)

35 calender roll

36 calender roll

37 calender roll

38 calender roll

39 calender roll

40 calender roll (bottom roll of the second stack)

42 second frame

44 guiding roll

46 reel-up

48 pressure roll

50 reel change device

52 reel spool storage

54 flyer roll

56 interconnection section

58 tail threading device

60 levers in first stack

62 levers in second stack

1. Method for treating a web (W) with heat and compression in a calender arrangement (13), in addition to a first stack (15) the calender arrangement is provided with a second stack (33) each of which including one or more calendering nips (0), the calendering treatment is selected to be performed in calendering nips (0) which can be of the first stack (15) and/or of the second stack (33) where both of the stacks (15, 33) or part of the stacks (15, 33) can be used independently or as a combination together with the other stack (15, 33) or part of the other stack (15, 33).

2. Method according to claim 1 characterized in that the web (W) in a first selectable treating mode is guided first through all of the nips (0) of the first stack (15) and after that through all of the nips (0) of the second stack (33).

3. Method according to claim 1 characterized in that the web (W) in a second selectable treating mode is guided first partially through the nips (0) of the first stack (15) and after that at least partially through nips (0) of the second stack (33).

4. Method according to claim 1 characterized in that the web (W) in a third selectable treating mode is guided first partially through the nips (0) of the first stack (15) and after that at least partially through the nips (0) of the second stack (33) and after that partially through the remaining nips (0) of the first stack (15).

5. Method according to claim 1 characterized in that the web (W) in a fourth selectable treating mode is guided first partially through the nips (0) of the second stack (33) and after that at least partially through nips (0) of the first stack (15).

6. Method according to claim 1 characterized in that the web (W) in a fifth selectable treating mode is guided first partially through the nips (0) of the second stack (33) and after that at least partially through the nips (0) of the first stack (15) and after that partially through the remaining nips (0) of the second stack (33).

7. A calender arrangement (13) for treating a web (W) with heat and compression wherein in addition to a first stack (15) the calender arrangement is provided with a second stack (33) each of which including one or more calendering nips (0), characterized in that the calendering nips (0) to be used are selectable out of the first stack (15) and/or of the second stack (33) wherein both of the stacks (15, 33) or parts of the stacks (15, 33) are useable independently or as a combination together with the other stack (15, 33) or parts of the other stack (15, 33).

8. A calender arrangement according to claim 7 the first stack (15) is arranged on a first frame (17) characterized in that the second stack (33) is arranged on a second frame (42) and said second frame (42) is removable and adjustable connected to the first frame (17).

9. A calender arrangement according to claim 7 and 8 characterized in that said second frame (42) is adjustable in position in relation to the first frame (17) such that the adjustment is feasible in the directions X, Y or Z independently from each others.

10. A calender arrangement according to claim 7 characterized in that the web (W) is guided first through the nips (0) of the first stack (15) and after that through the nips (0) of the second stack (33).

11. A calender arrangement according to claim 7 characterized in that the web (W) is guided first partially through the nips (0) of the first stack (15) and after that at least partially through nips (0) of the second stack (33).

12. A calender arrangement according to claim 7 characterized in that the web (W) is guided first partially through the nips (0) of the first stack (15) and after that at least partially through the nips (0) of the second stack (33) and after that partially through the remaining nips (0) of the first stack (15).

13. A calender arrangement according to claim 7 characterized in that the web (W) is guided first partially through the nips (0) of the second stack (33) and after that at least partially through nips (0) of the first stack (15).

14. A calender arrangement according to claim 7 characterized in that the web (W) is guided first partially through the nips (0) of the second stack (33) and after that at least partially through the nips (0) of the first stack (15) and after that partially through the remaining nips (0) of the second stack (33).
